(19) United States
(12) Patent Application Publication
(10) Pub. No.: US 2012/0313394 A1
(43) Pub. Date: Dec. 13, 2012

(54) SIDE CARGO LOADING VEHICLE

(75) Inventors: Andrew E. Barrow, Marysville, OH (US); Jason Dilley, Marysville, OH (US); Justin T. Longwell, Westerville, OH (US); Paul T. Aebker, Dublin, OH (US)

(73) Assignee: Honda Motor Co., Ltd.

(21) Appl. No.: 13/158,817

(22) Filed: Jun. 13, 2011

(51) Int. Cl. B60N 2/01; B23P 23/00

(52) U.S. Cl. 296/64; 29/401.1

(57) ABSTRACT

According to a first embodiment, an automotive vehicle having an adjustable seating configuration is disclosed. The vehicle includes an occupant compartment having a driver side and a passenger side. The passenger side is closed by a pair of side doors, the front door having a hinged connection toward a forward end of the vehicle and a rear door having a hinged connection toward a rearward end of the vehicle. Front and rear passenger seats are provided in the occupant compartment with the seat backs of the rear passenger seat and the front passenger seat being foldable in a forward direction. In addition, the front passenger seat base is rotatable in a forward direction and stowed within a recess in the vehicle instrument panel.

### BACKGROUND

The present exemplary embodiment relates generally to automotive vehicle seats, seating assemblies and cargo storage. It finds particular application in a vehicle that is adaptable for use in cargo transport as well as function as a passenger vehicle.

In the automotive arts, it is known that the manner of arranging the seats within the vehicle can provide adaptability between maximum seating and maximum cargo carrying capacity. The manner of hinging the doors and the manner of attaching seat backs and bases have been used to selectively increase seating or cargo space. For example, sport utility type vehicles may be equipped with folding rear and optionally third row seats to facilitate conversion of a passenger space into a cargo storage area. Similarly, it is known to provide van and/or mini-van style vehicles with removable rear and/or third row passenger seating to convert an aft portion of the vehicle into a larger cargo storage area. There has, however, been limited effort to increase cargo storage capacity of a sedan style of vehicle. One example of a sedan style vehicle having side loading means to increase storage space is provided in U.S. Pat. No. 2,997,336.

Referring to FIG. 1, doors 11, 12 respectively are hinged at each side of the vehicle. The front door 11 on each side of the vehicle is hinged at its front edge whereas the rear door 12 on each side of the vehicle is hinged adjacent its rear edge. It will be noted that the so-called “middle post” 13 is a relatively short member that extends upwardly only to about the height of the top of the seat unit cushions. In conventional four door vehicle bodies the “middle” post extends from the sill 14 to the top 15 of the vehicle.

The front and middle seat units 25, 26 and 32 respectively face forwardly whereas the rear seat unit (not shown) faces rearwardly. The front seat is composed of two separate seat units 25 and 26 respectively. Seat unit 26 is composed of a back section 27 and a seat section 28 wherein each of the sections are pivotally mounted for folding and unfolding. The seat section 28 may be extended forwardly to approximately the fire wall between the passenger compartment and the engine compartment. Likewise, the back section 27 of the front passenger seat unit 26 is pivotally mounted at 31 on the base frame 29 such that it may be turned down wherein the back portion thereof is coplanar with the underside of the inverted seat section 28. Seat unit 25 can be identical to the seat unit 26 so that seat unit 25 may be unfolded to permit loading the vehicle through doors on the drivers side of the vehicle.

The middle seat unit 32 is composed of a back section 33 and a seat section 34. The seat section 34 is hingedly mounted at 35 on the base frame 36 such that it may be inverted forwardly in the same manner as the front seat section 28. The back section 33 of the middle seat 32 is hingedly mounted by means which permit it to be pivoted forwardly so that the back portion thereof may be arranged in coplanar relationship with the underside of the inverted seat section 34. A fixed floor section 42 is provided between a rear seat and the middle seat 32.

It is a feature of this disclosure to provide an automotive vehicle with an improved side loading cargo area. The present disclosure describes increasing cargo storage of a sedan style of vehicle via an improved side loading design; however, it is envisioned that the particular embodiments disclosed herein could be incorporated into other vehicle types including sports utility, van and mini-van.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

According to a first embodiment, an automotive vehicle having an adjustable seating configuration is disclosed. The vehicle includes an occupant compartment having a driver side and a passenger side. The passenger side is closed by a pair of side doors, the front door having a hinged connection toward a forward end of the vehicle and a rear door having a hinged connection toward a rearward end of the vehicle. Front and rear passenger seats are provided in the occupant compartment with the seat backs of the rear passenger seat and the front passenger seat being foldable in a forward direction. In addition, the front passenger seat base is rotatable in a forward direction.

According to a second embodiment, a method for converting an automotive vehicle occupant compartment into a cargo storage area is provided. The method includes opening a front passenger side door having a hinged connection toward a front end of the vehicle and opening a rear passenger side door having a hinged connection toward a rear end of the vehicle to expose at least a substantial portion of the occupant compartment. A seat back of a rear passenger seat is folded in a forward direction to expose a rear cargo area. A seat back of a front passenger seat is folded in a forward direction and the front passenger seat is rotated forward into a recessed area of an instrument panel of the vehicle.

According to an additional embodiment, a vehicle having an occupant compartment positioned above a vehicle floor is provided; an instrument panel is positioned at a forward end of the occupant compartment, the instrument panel defining a seat storage cavity. A seat having a seat back and a seat base is rotatably mounted on the vehicle floor. The seat back is pivotally coupled to the seat base to allow the seat back to fold with respect to the seat base, the seat base is rotatably coupled to the vehicle floor such that the seat is movable to be stowed in the seat storage cavity in the instrument panel.

According to a further embodiment, a vehicle seating assembly is provided. The assembly includes a seat base having a surface configured to receive a passenger and an opposed surface. A pivoting mechanism pivotally couples the seat base to an associated vehicle floor. A seat back is pivotally coupled to the seat base and moveable between an upright position and a folded position. The seat base includes one of a latch and a striker for releasably engaging an associated floor mounted striker or latch, wherein release of the latch allows for rotation of the seat back about the pivoting mechanism located adjacent a front portion of the seat base into a stowed orientation. The seat base further includes a means for storing an article on said opposed surface that is exposed when the seat base is in the stowed position.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a side view of a prior art vehicle;

FIG. 2 is a side view of a first embodiment of a vehicle with seats in an upright position;

FIG. 3 is a side view of a first embodiment of a vehicle with seats in a folded position;

FIG. 4 is a perspective view of the cargo and passenger compartments of the vehicle of FIG. 2 with the body partially removed with rear seats in a folded condition;

FIG. 5 is a perspective view of the vehicle of FIG. 4 with seats in a folded condition and the front passenger seat in a folded condition;

FIG. 6 is a perspective view of the vehicle of FIG. 5 with rear seats in a folded condition and the front passenger seat in a folded, tumbled and stored position;

FIG. 7 is a perspective view of the vehicle of FIG. 6 with the rear passenger seat folded rearwardly to provide a wider cargo area; and,

FIG. 8 is a perspective view of the instrument panel of the vehicle.

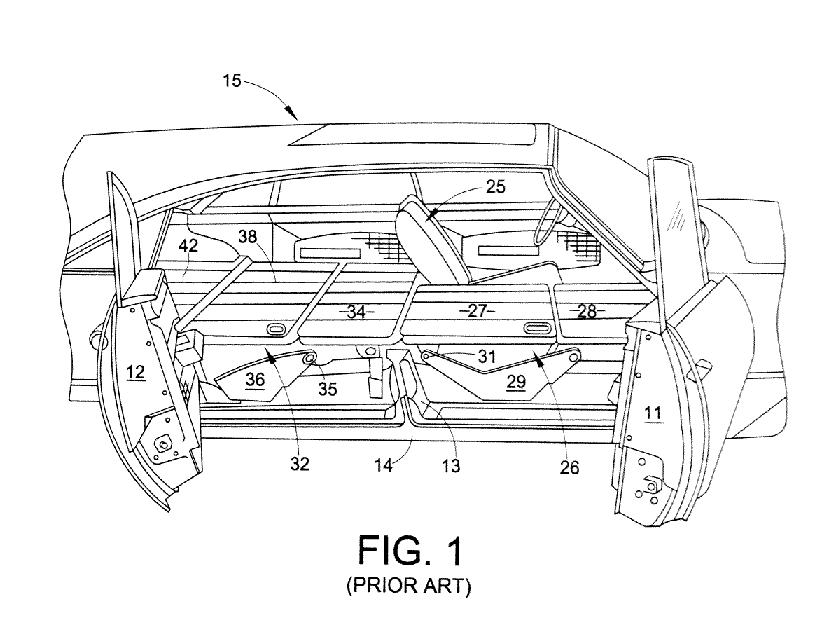

### DETAILED DESCRIPTION

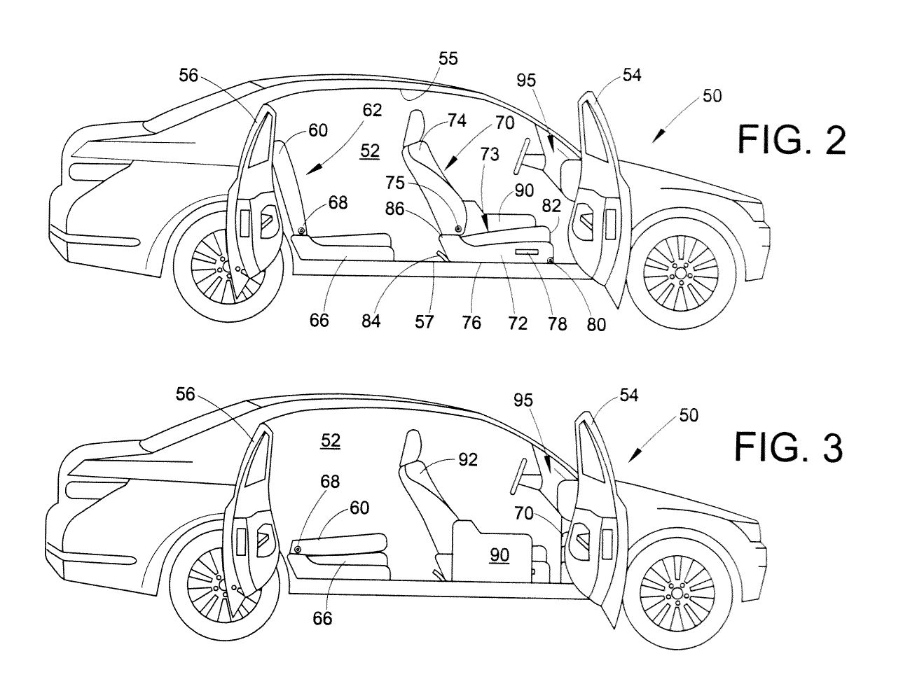

With reference to FIG. 2, a vehicle 50 is depicted. An occupant compartment 52 is selectively sealable on the passenger side of the vehicle via front door 54 and rear door 56. Front door 54 is secured to vehicle 50 at a forward edge via a hinged connection (not shown) or any other mechanism suitable in the art. Rear door 56 is secured to vehicle 50 at a rear edge via a hinge or any other mechanism suitable in the art. The driver side doors can be of the same configuration or a traditional design having both front and rear doors hinged at a forward end.

Upon opening of each of front door 54 and rear door 56, at least substantially all of occupant compartment 52 can be accessed from the side of the vehicle 50. To achieve maximum access to occupant compartment 52, the hinge connection of front door 54 can be located adjacent or forward of an instrument panel. Similarly, the hinge connection of rear door 56 can be located adjacent or rearward of seat back 60 of rear passenger seat 62 in its upright position.

To provide maximum access to occupant compartment 52, a B-pillar is not included on the vehicle 50. As an alternative, rear door 56 can be provided with releasable members (not shown) receivable within receptacles in top surface 55 and bottom surface 57 of vehicle 50. More particularly, rear door 56 can be provided with a handle, lever or other mechanism (even electronic) to activate the releasable elements providing selective engagement between rear door 56 and vehicle 50. When the releasable elements are engaged with vehicle 50, the leading edge of rear door 56 can function as a side pillar. A latch assembly in front door 54 and a striker assembly in rear door 56, for example, can be utilized to selectively join front door 54 to rear door 56 and close occupant compartment 52 on the passenger side of vehicle 50.

A front passenger seat 70 includes a seat base 72 having a surface 73 for supporting an occupant and a seat back 74 pivotally coupled to the seat base 72. Seat back 74 is provided with a pivot mechanism 75 allowing seat back 74 to fold forward to overlap surface 73 of seat base 72. The seat base 72 is mounted to the floor 76 of vehicle 50. Typically, the front passenger seat base 72 can be either a manually adjustable seat or can be provided with electric motors to provide automated adjustment via electronic control lever 78.

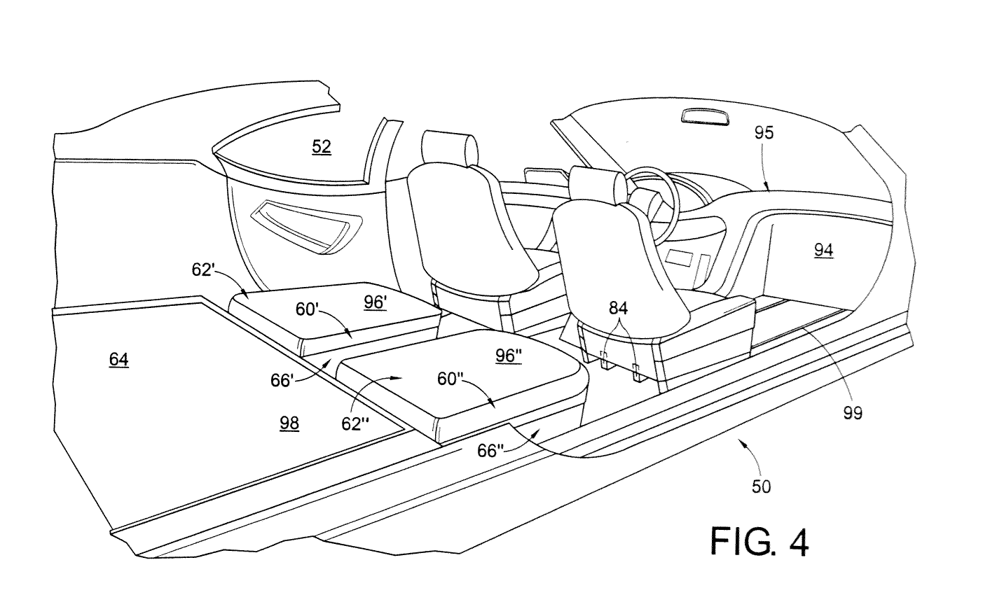

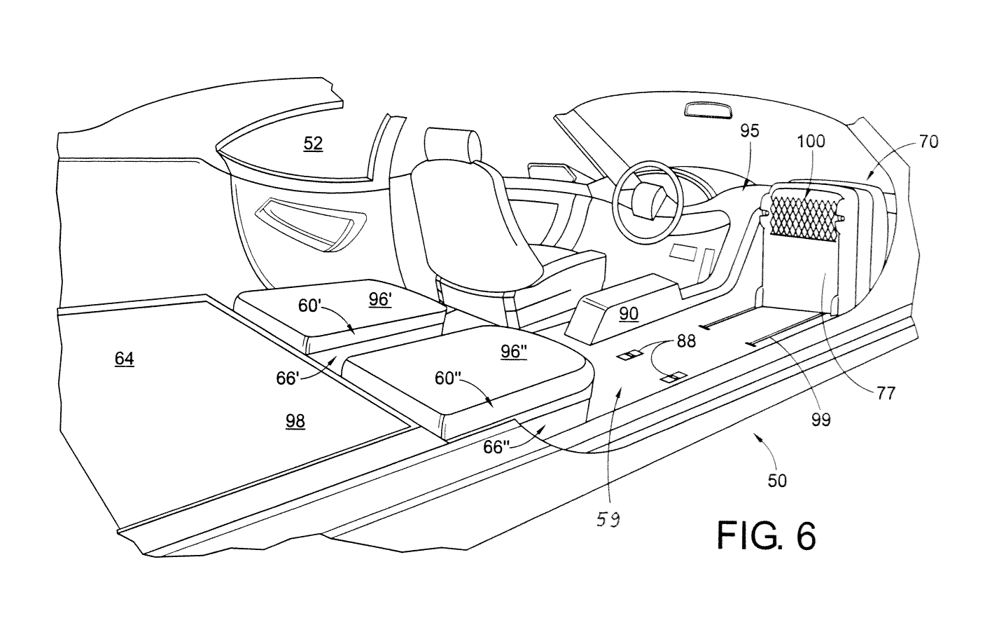

The seat base 72 is pivotally connected to the vehicle floor 76 via a pivoting mechanism 80 connected to a front section 82 of the seat base 72 and to the floor 76. A seat latch 84 (optionally a pair) is operatively associated with a rear section 86 of the seat base 72 in a manner known in the art. The seat latch 84 is releasably secured to a floor mounted striker 88 (see FIG. 6) or vice versa. Actuation of the seat latch 84 allows pivotable movement of the passenger seat 70 about the pivoting mechanism 80. Upon release of seat latch 84, the pivot connection permits the passenger seat 70 to rotate toward the front of vehicle 50 about an axis defined by the pivoting mechanism 80. Typically, seat back 74 is first folded forward into overlap with surface 73 before the seat 70 is rotated forward. This has been referred to in the art as a fold and tumble seat. Furthermore, it is noted that a track mechanism (see 99 in FIGS. 4-6) can be provided in the vehicle floor 76 to facilitate sliding front passenger seat 70 into its stored location. Moreover, a tongue element (not shown) secures front section 82 slidably with track 99.

Rear passenger seat 62 includes a seat back 60, pivotably connected to a seat base 66 via a pivot mechanism 68. It should be appreciated that the seat pivoting mechanisms can be any mechanism suitable for pivoting the seat back between an upright seating position (optionally reclined) and a folded position as is commonly known in the art. In this manner, seat back 60 can be forward folded to overlap seat base 66 (see FIG. 3), to expose a cargo area 64 rearward of seat back 60 to the occupant compartment 52. More particularly, and referring to FIG. 3, releasing seat back 60 and allowing its forward rotation around pivot mechanism 68, such that seat back 60 overlaps seat base 66, provides a passage into a rear cargo storage area such as a trunk. As demonstrated in FIG. 6, a significant increase in storage surface area is established by providing an access to storage cargo area 64 adjacent folded rear passenger seating 62. It is noted that rear passenger seat 62 can be comprised of a plurality of cooperative individual base and back components or consist of a bench type seat.

Referring again to FIG. 3, improved access and increased storage area is further achieved because front passenger seat 70 is folded and tumbled into a stowed position within a recess in the instrument panel 95 of the vehicle 50. A large space is created between the passenger side opening and the vehicles center console 90 and driver seat 92. More particularly, it can be seen that front passenger seat 70 has been removed from its position suited for passenger seating by being folded, tumbled and stowed as is more fully depicted in the following FIGS. 4-6.

Referring now to FIGS. 4-6, the conversion methodology for transforming vehicle 50 from a primarily passenger carrying automotive vehicle to a predominantly cargo storing automotive vehicle is depicted. A variety of steps are set forth, however, a specific order is not necessarily followed to achieve the desired end result.

Referring first to FIG. 4, passenger compartment 52 is exposed via the opening of front door 54 and rear door 56 (not shown) to provide side cargo access 59. Seat backs 60′ and 60″ of rear passenger seats 62′ and 62″, respectively, are folded into an overlapping position with rear seat base 66′ and 66″. Advantageously, the rear surfaces 96′ and 96″ of seat backs 60′ and 60″ in a folded condition can be coplanar with the storage deck 98 of cargo storage compartment 64. In this manner, a large planar storage surface is provided.

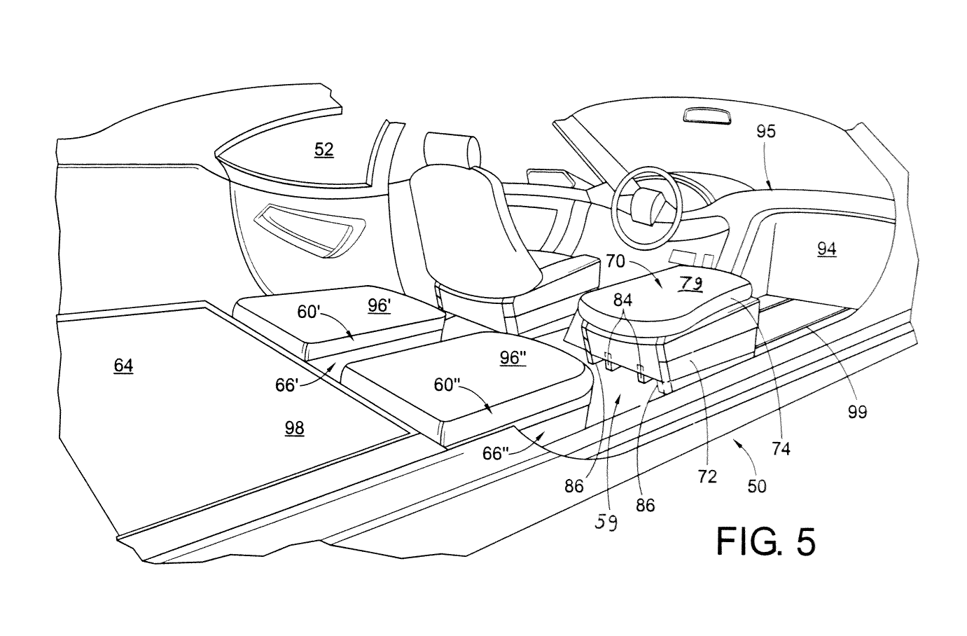

Referring now to FIG. 5, the storage area and advantageously access to a large storage area is provided by folding front seat back 74 into an overlapping position with front seat base 72. Furthermore, access to cargo storage compartment 64 is improved such that elongated cargo could be more readily loaded into the vehicle 50. Similarly, it is noted that the rear surface 79 of front passenger seat back 74 can form a cooperative and coplanar storage surface if desired.

Release of latches 84 frees seat base 72 from strikers 88 and allows the rotation of seat 70 about pivot mechanism 80 such that folded seat 70 is transverse (see FIG. 6) relative to its original position. In this manner, bottom surface 77 of seat base 72 becomes exposed and perpendicular to the floor 76 of the vehicle 50. A wheel arrangement (not shown) can be provided on the front section 82 of front passenger seat 70 to allow seat 70 to be rolled forward into a recess 94 (see FIGS. 4 and 5) in the vehicle instrument panel 95. Alternatively, a track system 99 (or other means) receiving an elongated tongue element secured to seat base 72 can be mounted to the vehicle floor to allow folded and tumbled seat 70 to slide into a forward position within the recess 94 in the vehicle instrument panel 95. In this manner, increased access is provided to the storage compartment to facilitate the loading of cargo. This design can be particularly beneficial in a vehicle which does not include rear trunk access.

Bottom surface 77 of front passenger seat 70 can be provided with a means for retention of articles. Moreover, in its stowed position, surface 77 of seat 70 is exposed to the vehicle occupant compartment 52 and can advantageously include elements such as a cup holder, netting, a covered storage compartment, a pocket, hook elements, a cavity, or other device known to the skilled artisan suitable for storage of objects. A net 100 is depicted in FIG. 6. Furthermore, it is noted that a releasable retention mechanism (such as clips, bands, hooks, etc.; not shown) can be provided to retain the stowed front passenger seat 70 within recess 94 in instrument panel 95.

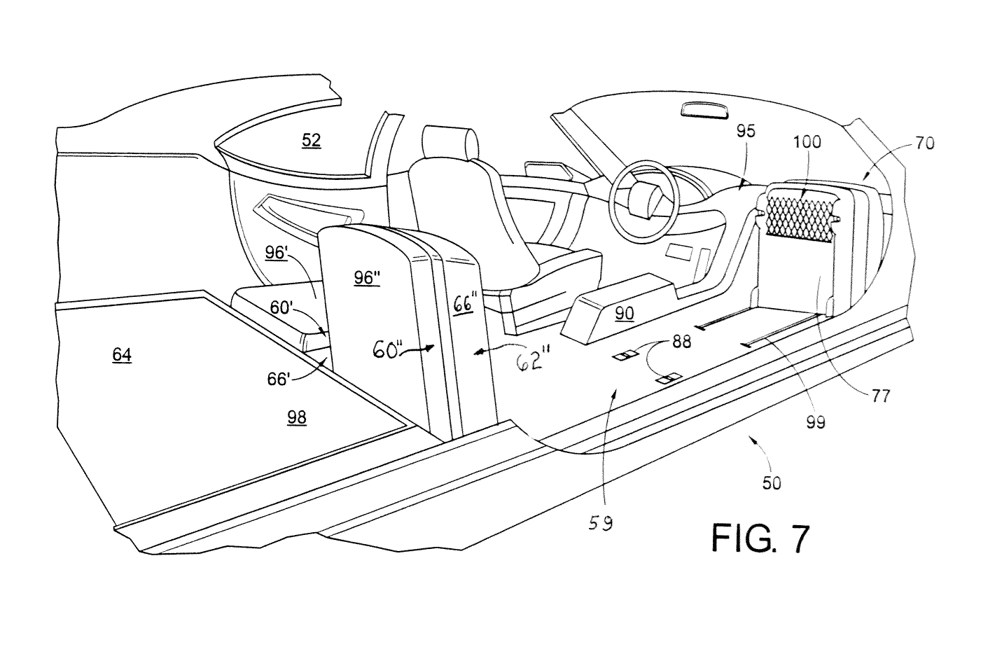

Referring now to FIG. 7, an alternative embodiment is displayed wherein rear passenger seat 62′ includes a tumble mechanism, allowing it to be rotated adjacent to cargo area 64. This provides a significant increase in the area of side cargo access 59. The tumble mechanism for rear passenger seat 62′ can be similar to what is provided with front passenger seat 70 or to any other system contemplated by the automobile engineer. Similarly, it is envisioned that rear passenger seat 60′ could also be rearwardly tumbled or that a rear bench seat could be rearwardly tumbled.

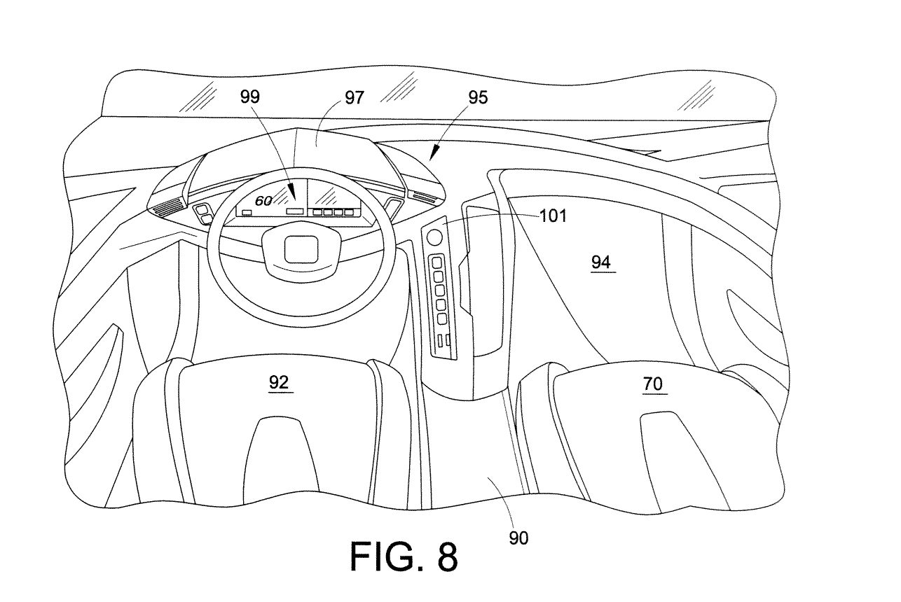

Referring now to FIG. 8, a perspective view of instrument panel 95 is provided. More particularly, instrument panel 95 includes a dashboard 97 housing a display 99, and a radio 101 in a portion of the instrument panel that transitions into center console 90 disposed between driver's seat 92 and front passenger seat 70. Instrument panel 95 further defines a recess 94 forward of front passenger seat 70. Recess 94 is generally of a size and shape suitable for receiving front passenger seat 70 subsequent to the fold and tumble operation previously described.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An automotive vehicle including an adjustable seating configuration the vehicle comprising an occupant compartment having a driver side and a passenger side, the passenger side being closed by a pair of side doors, a front door having a hinged connection toward a forward end of the vehicle and a rear door having a hinged connection toward a rearward end of the vehicle, front and rear passenger seats residing in said compartment wherein a seat back of said rear passenger seat is foldable in a forward direction and a seat back of said front passenger seat is foldable in a forward direction and a base of the front passenger seat is further rotatable in a forward direction.

2. The vehicle of claim 1 including a seat storage cavity in an instrument panel of said vehicle.

3. The vehicle of claim 1 wherein a rear storage area is exposed to said occupant compartment when said rear passenger seat is in a folded condition.

4. The vehicle of claim 1 comprised of a plurality of rear passenger seats having individual forward folding seat backs.

5. The vehicle of claim 1 wherein said rear storage area includes a deck, said deck being at least substantially coplanar to an exposed surface of said rear passenger seat back in a folded condition.

6. The vehicle of claim 2 wherein said cavity is configured to receive said folded front passenger seat.

7. The vehicle of claim 1 wherein said front and rear doors are interlocking in a closed condition.

8. The vehicle of claim 2 wherein a hinged end of said front door is generally adjacent or forward of said instrument panel and a hinged end of said rear door is generally adjacent or rearward of said rear passenger seat back in an upright condition.

9. The vehicle of claim 2 wherein said front passenger seat back is pivotally coupled to a seat base and said seat base is pivotally coupled to an associated vehicle floor.

10. The vehicle of claim 9 further comprising a front passenger seat latch for releasably securing said seat base to an associated vehicle floor mounted striker, wherein activation of the seat latch allows for said rotatable movement of the front passenger seat about the pivoting mechanism.

11. The vehicle of claim 10 wherein said vehicle floor further includes a track receiving said passenger seat base.

12. The vehicle of claim 1 wherein a B-pillar is not present.

13. A method for converting an automotive vehicle occupant compartment into a cargo area storage, the method comprising opening a front passenger side door having a hinged connection toward a front end of the vehicle and opening a rear passenger side door having a hinged connection toward a rear end of the vehicle to expose at least a substantial portion of said occupant compartment, folding a seat back of a rear passenger seat in a forward direction to expose a rear cargo area, folding a seat back of a front passenger seat in a forward direction rotating said front passenger seat forward and stowing said front passenger seat in a recessed area of an instrument panel of said vehicle.

14. The method of claim 13 wherein in a folded position, a rear surface of said rear passenger seat is substantially co-planar with a deck surface for said rear cargo area.

15. The method of claim 13 wherein a latch is associated with a base of said front passenger seat to releasably secure the seat to the vehicle.

16. The method of claim 13 wherein said front passenger seat is slid via a track into the stowed position.

17. The method of claim 3 further comprising securing said passenger seat to said instrument panel.

18. A vehicle comprising:
an occupant compartment positioned above a vehicle floor;
an instrument panel positioned at a forward end of the occupant compartment, the instrument panel defining a seat storage cavity and further including a releasable tension mechanism to retain a front occupant compartment seat;
the front occupant compartment seat being rotatably mounted on the vehicle floor, the seat having a seat back and a seat base, the seat base including a first occupant receiving side and an opposed side including a means for storing an article, the seat back being pivotally coupled to the seat base to allow the seat back to fold with respect to the seat base, the seat base being rotatably coupled to the vehicle floor such that the seat is movable to be stowed in the seat storage cavity in the instrument panel.

19. The vehicle of claim 18 further including at least one rear passenger seat, said rear passenger seat having a seat back and a seat base, the seat back being pivotally connected to the seat base to allow the seat back to fold with respect to the seat base, the seat base being rotatably coupled to the vehicle floor such that the rear passenger seat is moveable away from the instrument panel.

20. A vehicle seat assembly comprising a seat base having a surface configured to receive a passenger and an opposed surface, a pivoting mechanism for pivotally coupling the seat base to an associated vehicle floor, a seat back pivotally coupled to the seat base and moveable between an upright position and a folded position, the seat base including one of a latch and a striker for releasably engaging an associated floor mounted latch or striker, wherein release of the latch allows for rotation of the seat base about a pivoting mechanism located adjacent a front portion of the seat base into a stowed orientation, and wherein a bottom surface of the seat base includes a means for storing an article which is exposed upon rotation of said seat base into the stowed orientation

21. The vehicle seat assembly of claim 20 wherein said means for storing is selected from at least one of a net, a cavity, a compartment, a pocket and a hook.

22. The vehicle of claim 5 wherein said exposed surface of said front passenger seat back in a folded condition is at least substantially coplanar to said deck and the exposed surface of said rear passenger seat back in a folded condition.
